(19) United States
(12) Patent Application Publication
(10) Pub. No.: US 2026/0265487 A1
(43) Pub. Date: Sep. 10, 2026

(54) rPVB IN MULTILAYER SPORTS FLOORING

(71) Applicant: BeNewtral Srl - Società Benefit, Milano (IT)

(72) Inventor: Nicolò Verardi, Milan (IT)

(21) Appl. No.: 19/559,987

(22) Filed: Mar. 7, 2026

(30) Foreign Application Priority Data
Mar. 7, 2025 (EP) 25162418.5

(51) Int. Cl. C08K 3/34; C08L 29/04; E04F 15/10

(52) U.S. Cl. CPC C08K 3/34; C08L 29/04; E04F 15/107; C08K 2201/005; C08L 2207/20

(57) ABSTRACT

A composition comprising rPVB (recycled polyvinyl butyral), hydroxyethyl cellulose and sodium silicate, and formulations comprising the same, is the subject matter of the present disclosure. A multilayer system for sports flooring comprising said formulations is also subject matter of the present disclosure.

### TECHNICAL FIELD

The present disclosure relates to multilayer sports flooring comprising rPVB (recycled polyvinyl butyral).

### BACKGROUND

PVB is an essential component of car windscreens, where it is placed to guarantee the safety and shatter-resistance of laminated glass.

Every year, more than 25 million vehicles reach the end of their service life worldwide. There is therefore an abundance of PVB waste available worldwide.

U.S. Pat. No. 10,626,241B2 describes a currently implemented process to recover the PVB contained in discarded windscreen glass, thus transforming polluting waste into a raw material, known as rPVB.

rPVB is widely used in the paint industry and the eco-leather industry.

The water-based latex of rPVB is characterised by a Minimum Film Forming Temperature (MFFT) of 0° C. Its density is 1.03 g/cm³, it has a pH of around 10.5, viscosity of around 50-200 mPa*s and particle size that is less than 300 nm.

In applications such as flooring, due to the above parameters, rPVB has disadvantages compared to typically used binders such as, acrylic, styrene-acrylic and polyurethane resins. In particular:
1. high cross-linking/film forming speed, with increased formation of unwanted surface skins;
2. poor cold adhesion;
3. high sensitivity to water.

The need is still perceived for new ways to re-use rPVB, which thanks to recovery techniques is now widely available.

### DESCRIPTION

A composition comprising rPVB, hydroxy ethyl cellulose and sodium silicate forms first subject matter of the present disclosure.

In some embodiments, said hydroxy ethyl cellulose is a white powder with a particle size less than 180 μm, having a viscosity in the range of 4,200-5,500 mPa*s, a pH between 6 and 8.5, e.g., 7, and a density of 0.45 g/cm³.

In said composition, the sodium silicate can be selected to ensure a high molecular weight and a low weight ratio of SiO₂ to Na₂O. In some embodiments, the weight ratio between SiO₂ and Na₂O is in the range of 1.6-2, for example, 1.60.

In some embodiments, said sodium silicate has a pH between 12.6 and 13.8 and a viscosity between 200 and 600 mPa*s.

In some embodiments, said composition comprises:
rPVB in an amount between 90% and 98%, between 92% and 97%, between 94% and 97%, or between 95% and 97%;
Hydroxy ethyl cellulose in an amount between 1.00% and 3.00%, between 1.10% and 2%, or between 1.10% and 1.8%;
Sodium silicate in an amount between 1.00% and 5.00%, between 1.90% and 4.00%, or between 1.90% and 3.20%.

In some embodiments, said composition comprises:
rPVB 95.18%;
Hydroxy ethyl cellulose 1.75%; and
Sodium silicate 3.07%.

In some embodiments, said composition comprises:
rPVB 95.18%;
Hydroxy ethyl cellulose 1.73%; and
Sodium silicate 3.08%.

In some embodiments, said composition comprises:
rPVB 95.82%;
Hydroxy ethyl cellulose 1.52%; and
Sodium silicate 2.66%.

In some embodiments, said composition comprises:
rPVB 96.97%;

Hydroxy ethyl cellulose 1.10%; and

Sodium silicate 1.93%.

In some embodiments, the composition comprising rPVB, hydroxy ethyl cellulose and sodium silicate has a viscosity in the range of 1,000-3,000 mPa*s, e.g., 2,000 mPa*s and a pH between 8 and 10, e.g., 9.

This composition can conveniently be used in formulations suitable for forming multilayer sports flooring.

Therefore, formulations comprising the composition according to the present disclosure, adapted to be used in multilayer sports flooring, are further subject matter of the present disclosure.

In some embodiments, said formulation comprises the composition according to the present disclosure, a filler, such as micronised glass and/or round sand, and a dispersing additive.

### Optionally, Said Formulation Also Comprises a Dye.

Said sand conveniently has a particle size in the range of with a particle size of greater than 0 to 0.45 mm, or 0-0.25 mm.

The particle size is measured by sieving, for example, using column vibratory sieves, where the sieve with the largest mesh size has openings of 0.45 mm or 0.25 mm.

In some embodiments, 100% of the sand passes through a 0.45 mm sieve, as determined by sieving.

In some embodiments, 100% of the sand passes through a 0.25 mm sieve, as determined by sieving.

In some embodiments, said micronised glass is obtained 100% from recycling.

In some embodiments, said formulation comprises:
composition according to the present disclosure in an amount of 25-40%, or 30-50%;
micronised glass in an amount of 15-25% or 18-22%;
sand in an amount of 15-55% or 30-50%;
dispersing additive in an amount of 0.25-0.40%
dye in an amount of 0-6%.

Said formulation is conveniently dispersed in water. In some embodiments, said formulation is dispersed in an amount between 70% and 80%, preferably between 72% and 79% (w/w).

In some embodiments, said formulation, referred to as a “filling base”, comprises the composition according to the present disclosure, a filler, such as micronised glass and/or round sand having a particle size of greater than 0 to 0.45 mm, as well as a dispersing additive.

In some embodiments, said “filling base” formulation comprises (% weight/weight):
the composition according to the present disclosure in an amount of 25-40% or 30-38%;
micronised glass in an amount of 15-25% or 18-22%;
sand with a particle size of greater than 0 to 0.45 mm in an amount of 25-55% or 30-50%; and
dispersing additive in an amount of 0.25-0.40%.

In some embodiments, said “filling base” formulation comprises (% weight):
the composition according to the present disclosure in an amount of 34.06%;
micronised glass in an amount of 20.20%;
sand with a particle size of greater than 0 to 0.45 mm in an amount of 45.41%; and
dispersing additive in an amount of 0.32%.

In some embodiments, said composition according to the present disclosure in the “filling base” formulation comprises:
rPVB 95.18%;
Hydroxy ethyl cellulose 1.75%; and
Sodium silicate 3.07%.

In some embodiments, said formulation is dispersed in water. In some embodiments, said formulation is dispersed in water in a percentage of about 77.36% (w/w).

In some embodiments, said formulation, referred to as “elastic filling base” comprises the composition according to the present disclosure, a filler such as micronised glass and/or round sand having a particle size of greater than 0 to 0.45 mm, a dispersing additive, and a dye.

In some embodiments, said “elastic filling base” formulation comprises (% weight/weight):
the composition according to the present disclosure in an amount of 25-40% or 30-38%;
micronised glass in an amount of 15-25% or 18-22%;
sand with a particle size of greater than 0 to 0.45 mm in an amount of 25-55% or 30-50%;
dispersing additive in an amount of 0.25-0.40%; and
dye in an amount of 1-3%.

In an embodiment, said “elastic filling base” formulation comprises (% weight):
the composition according to the present disclosure in an amount of 33.40%;
micronised glass in an amount of 19.82%;
sand with a particle size of greater than 0 to 0.45 mm in an amount of 44.53%;
dispersing additive in an amount of 0.32%;
dye in an amount of 1.93%.

In some embodiments, said formulation is dispersed in water. In some embodiments, said formulation is dispersed in water in a percentage of about 77.70%.

In some embodiments, said composition according to the present disclosure in the “elastic filling base” formulation comprises:
rPVB 95.18%;
Hydroxy ethyl cellulose 1.75%; and
Sodium silicate 3.07%.

In some embodiments, said formulation, referred to as “coloured finish” comprises the composition according to the present disclosure, a filler, such as micronised glass and/or round sand having a particle size of greater than 0 to 0.25 mm, a dispersing additive, and a dye.

In an embodiment, said “coloured finish” formulation comprises (% weight):
the composition according to the present disclosure in an amount of 25-40% or 30-38%;
micronised glass in an amount of 15-25% or 18-22%;
sand with a particle size of greater than 0 to 0.25 mm in an amount of 25-55% or 32-52%;
dispersing additive in an amount of 0.20-0.32%; and
dye in an amount of 3-6%.

In some embodiments, said “coloured finish” formulation comprises (% weight):
the composition according to the present disclosure in an amount of 34.93%;
micronised glass in an amount of 20.32%;
sand with a particle size of greater than 0 to 0.25 mm in an amount of 39.84%;
dispersing additive in an amount of 0.27%; and
dye in an amount of 4.65%.

In some embodiments, said formulation is dispersed in water. In some embodiments, said formulation is dispersed in water in a percentage of about 75.30%.

In some embodiments, said composition according to the present disclosure in said “coloured finish” formulation comprises:
rPVB 95.82%;
Hydroxy ethyl cellulose 1.52%; and
Sodium silicate 2.66%.

In some embodiments, said formulation, referred to as “line coloured finish” comprises the composition according to the present disclosure, a filler, such as micronised glass and/or round sand having a particle size of greater than 0 to 0.25 mm, a dispersing additive, and a dye.

In some embodiments, said “line coloured finish” formulation comprises (% weight):
the composition according to the present disclosure in an amount of 30-60% or 35-55%;
micronised glass in an amount of 20-32% or 24-30%;
sand with a particle size of greater than 0 to 0.25 mm in an amount of 12-30% or 15-23%;
dispersing additive in an amount of 0.20-0.32%; and
dye in an amount of 3-6%.

In some embodiments, said “coloured finish” formulation comprises (% weight):
the composition according to the present disclosure in an amount of 48.21%; micronised glass in an amount of 26.96%;
sand with a particle size of greater than 0 to 0.25 mm in an amount of 19.92%;
dispersing additive in an amount of 0.27%; and
dye in an amount of 4.65%.

In some embodiments, said formulation is dispersed in water. In some embodiments, said formulation is dispersed in water in a percentage of about 75.30%.

In some embodiments, said composition according to the present disclosure in said “line coloured finish” formulation comprises:
rPVB 96.97%;
Hydroxy ethyl cellulose 1.10%; and
Sodium silicate 1.93%.

Further subject matter of the present disclosure is a multilayer system for sports floors.

A multilayer system usually laid on site is composed of a minimum of three layers, comprising an elastic filling base and two finishing layers, where said multilayer is laid on a base substrate that typically consists of concrete, asphalt or an elastomeric mat.

In some embodiments, said multilayer also includes a filling base and/or one or more coloured finishing layers.

In some embodiments, said multilayer also comprises, between said base substrate and said filling base, a primer.

Said elastic filling base is conveniently made up of the “elastic filling base” formulation.

Said finishing layers are conveniently made up of the “coloured finish” formulation.

Said filling base, where present, is conveniently made up of the “filling base” formulation.

Said coloured finishing layers, where present, are conveniently made up of the “line coloured finish” formulation.

In some embodiments, the subject matter of the present disclosure is the use of a composition according to the present disclosure in formulations for multilayer sports flooring.

In some embodiments, the subject matter of the present disclosure is a method for installing multilayer sports flooring, wherein said method comprises:
Providing an elastic filling base formulation, a coloured finish formulation and optionally a filling base formulation and/or a line coloured finish formulation;
Optionally, diluting said formulations with a percentage between 10 and 15% water (w/w), mixing appropriately;
Optionally, spreading a coat of filling base on a base substrate;
Spreading a coat of elastic filling base on a base substrate, possibly already covered with a coat of filling base;
Spreading two coats of coloured finish onto said coat of elastic filling base;
Optionally, spreading a coat of line coloured finish.

Between coats, leaving to dry, e.g. 12 h at 23° C. 50% RH, or 2-3 hours before the next application.

By way of example, a multilayer according to the present disclosure is detailed herein, comprising:
1. Filling base
2. Elastic filling base
3. Coloured finish
4. Coloured finish
5. Play lines.

Conveniently, said “coloured finish” formulation is applied in two steps, resulting in a multilayer comprising layer 3 and layer 4 of coloured finish.

Advantageously, the fine particle size characterising the “coloured finish” formulation, and the application of the same in two successive steps, allow for complete occlusion of the gaps left by the filling base and elastic filling base coats, creating a uniform surface.

Advantageously, the “line coloured finish” formulation is less viscous than the coloured finish layers due to the greater amount of composition according to the present disclosure included therein, and consequently quicker to lay.

In an embodiment, a multilayer was formed comprising:
1. Filling base, comprising
   the composition according to the present disclosure in an amount of 34.06%;
   micronised glass in an amount of 20.20%;
   sand with a particle size of greater than 0 to 0.45 mm in an amount of 45.41%; and
   dispersing additive in an amount of 0.32%
   where said filling base is dispersed in water at a percentage of approximately 77.36%.
2. Elastic filling base, comprising:
   the composition according to the present disclosure in an amount of 33.40%;
   micronised glass in an amount of 19.82%;
   sand with a particle size of greater than 0 to 0.45 mm in an amount of 44.53%;
   dispersing additive in an amount of 0.32%; and
   dye in an amount of 1.93%
   where said elastic filling base is dispersed in water at a percentage of approximately 77.70%.
3. Coloured finish, comprising:
   the composition according to the present disclosure in an amount of 34.93%;
   micronised glass in an amount of 20.32%;
   sand with a particle size of greater than 0 to 0.25 mm in an amount of 39.84%;
   dispersing additive in an amount of 0.27%; and
   dye in an amount of 4.65%
   where said coloured finish is dispersed in water in a percentage of approximately 75.30%.
4. Coloured finish, comprising:
   the composition according to the present disclosure in an amount of 34.93%;
   micronised glass in an amount of 20.32%;
   sand with a particle size of greater than 0 to 0.25 mm in an amount of 39.84%;
   dispersing additive in an amount of 0.27%; and
   dye in an amount of 4.65%
   where said coloured finish is dispersed in water in a percentage of approximately 75.30%.
5. Play lines, comprising
   the composition according to the present disclosure in an amount of 48.21%;
   micronised glass in an amount of 26.96%;
   sand with a particle size of greater than 0 to 0.25 mm in an amount of 19.92%;
   dispersing additive in an amount of 0.27%; and
   dye in an amount of 4.65%
   where said line coloured finish is dispersed in water in a percentage of approximately 75.30%.

The stability of the multilayer was tested as follows:

Resistance to liquids, tested according to the reference standard UNI EN ISO 2812-3: no degradation.

Thermal resistance, tested according to the reference standard UNI EN 1062-11: no degradation.

Dry abrasion resistance (Taber), tested according to reference standard EN 5470-1:<2 g.

Skid resistance (SRT), tested according to EN 1436 and EN 13036-4: S3; SRT=55.

UV resistance (colour change after 1000 hours of exposure), tested according to the reference standard UNI EN 1062-11: DeltaE<0.8.

The authors of the present disclosure have surprisingly demonstrated that the combination of rPVB with hydroxy ethyl cellulose and sodium silicate, in the quantities and under the conditions described above, allows rPVB latex to be used without its characteristics impairing its applicability in the field of multilayer coatings, e.g., suitable for both indoor and outdoor sports floors.

In particular, the combination surprisingly avoids rapid film forming, ensures improved adhesion to the substrate, and finally allows a glassy patina to cover the system when solidified, going so far as to eliminate the characteristic sensitivity of solidified rPVB latexes to water. This last aspect is of paramount importance, especially in outdoor flooring, which is subjected to the action of humidity and dew cycles, potentially damaging to rPVB.

Silicate in the quantities according to the present disclosure has been shown to be an essential component: its absence, or its presence in quantities below the range claimed here, has been shown to result in poor adhesion to the substrate, and from the very first layer the material laid showed a tendency to be removed during subsequent laying steps.

By using higher silicate concentrations than those proposed by the composition according to the present disclosure, an undesirable demixing and phase separation effect was observed between the silicate component and the rPVB latex.

In some embodiments, the concentration of cellulose remains within the range claimed here: a higher dosage, with the same amount of silicate, resulted in the material drying out already during the production stages, which made it objectively difficult to process, except by adding large quantities of water, which, however, resulted in a worsening of the overall properties of the system. On the other hand, a lower dosage of cellulose, with the same amount of silicate, resulted in a very liquid material lacking cohesion, so that it could be spread onto a substrate to form a uniform mass.

1. A composition comprising, by weight relative to the total composition:
from 90% to 98% of rPVB (recycled PolyVinyl Butyral)
from 1.00% to 3.00% Hydroxyethyl cellulose; and
from 1.00% to 5.00% Sodium silicate.

2. The composition according to claim 1, comprising:
from 95% to 97% rPVB;
from 1.10% to 1.8% Hydroxyethyl cellulose; and
from 1.90% to 3.20% Sodium silicate.

3. A formulation for use in multilayer sports floors systems, the formulation comprising by weight relative to the total formulation:
from 25% to 40% of the composition according to claim 1
from 15% to 25% glass;
from 15% to 55% sand
from 0.25% to 0.40% of a dispersing additive; and
from 0% to 6% of a dye.

4. A formulation for use in multilayer sports floors systems, the formulation comprising by weight relative to the total formulation:
from 30% to 38% of the composition according to claim 1;
from 18% to 22% micronized glass;
from 30% to 50% sand; and
from 0.25% to 0.40% of a dispersing additive;
wherein said sand has a particle size from greater than 0 to 0.45 mm.

5. The formulation according to claim 4, further comprising:
from 1% to 3% of a dye.

6. A formulation for use in multilayer sports floors systems, the formulation comprising by weight relative to the total formulation:
from 30% to 38% of the composition according to claim 1;
from 18% to 22% micronized glass;
from 32% to 52% sand;
from 0.20% to 0.32% of a dispersing additive; and
from 3% to 6% of a dye;
wherein the sand has a particle size from greater than 0 to 0.25 mm.

7. A formulation for use in multilayer sports floors systems, the formulation comprising by weight relative to the total formulation:
from 35% to 55% of the composition according to claim 1;
from 24% to 30% micronized glass;
from 15% to 23% sand;
from 0.20% to 0.32% of a dispersing additive; and
from 3% to 6% of a dye;
wherein the sand has a particle size from greater than 0 to 0.25 mm.

8. The formulation according to claim 3, wherein the formulation is dispersed in water and is present in an amount from 70% to 80% by weight relative to the total weight of the dispersion.

9. A multilayer system for sports floors comprising the formulation according to claim 3.

10. A multilayer system for sports floors comprising at least three layers: an elastic filling base layer comprising the formulation of claim 5 and two finishing layers, where said multilayer system is laid on a base substrate wherein the base substrate comprises concrete, asphalt or an elastomeric mat.

11. A multi-layer system, comprising:
a filling base layer comprising from 30% to 38% of a composition including from 90% to 98% of rPVB, from 1.00% to 3.00% hydroxyethyl cellulose, and from 1.00% to 5.00% sodium silicate; from 18% to 22% micronized glass; from 30% to 50% sand; and from 0.25% to 0.40% of a dispersing additive, wherein said sand has a particle size from greater than 0 to 0.45 mm; and
one or more coloured finishing layers, each comprising from 30% to 38% of a composition including from 90% to 98% of rPVB, from 1.00% to 3.00% hydroxyethyl cellulose, and from 1.00% to 5.00% sodium silicate; from 18% to 22% micronized glass;
from 32% to 52% sand; from 0.20% to 0.32% of a dispersing additive; and from 3% to 6% of a dye, wherein the sand has a particle size from greater than 0 to 0.25 mm.

12. A multilayer system comprising at least 5 layers in order of application:
i. a filling base layer comprising from 30% to 38% of a composition including from 90% to 98% of rPVB, from 1.00% to 3.00% hydroxyethyl cellulose, and from 1.00% to 5.00% sodium silicate; from 18% to 22% micronized glass; from 30% to 50% sand; and from 0.25% to 0.40% of a dispersing additive, wherein said sand has a particle size from greater than 0 to 0.45 mm;
ii. an elastic filling base layer comprising from 30% to 38% of a composition including from 90% to 98% of rPVB, from 1.00% to 3.00% hydroxyethyl cellulose, and from 1.00% to 5.00% sodium silicate; from 18% to 22% micronized glass; from 30% to 50% sand; from 0.25% to 0.40% of a dispersing additive; and from 1% to 3% of a dye; wherein the sand has a particle size from greater than 0 to 0.45 mm
iii. a first coloured finish layer comprising from 30% to 38% of a composition including from 90% to 98% of rPVB, from 1.00% to 3.00% hydroxyethyl cellulose, and from 1.00% to 5.00% sodium silicate; from 18% to 22% micronized glass; from 32% to 52% sand; from 0.20% to 0.32% of a dispersing additive; and from 3% to 6% of a dye, wherein the sand has a particle size from greater than 0 to 0.25 mm
iv. a second coloured finish layer comprising from 30% to 38% of a composition including from 90% to 98% of rPVB, from 1.00% to 3.00% hydroxyethyl cellulose, and from 1.00% to 5.00% sodium silicate; from 18% to 22% micronized glass; from 32% to 52% sand; from 0.20% to 0.32% of a dispersing additive; and from 3% to 6% of a dye, wherein the sand has a particle size from greater than 0 to 0.25 mm; and
v. a play lines layer comprising from 35% to 55% of a composition including from 90% to 98% of rPVB, from 1.00% to 3.00% hydroxyethyl cellulose, and from

1. 00% to 5.00% sodium silicate; from 24% to 30% micronized glass; from 15% to 23% sand; from 0.20% to 0.32% of a dispersing additive; and from 3% to 6% of a dye; wherein the sand has a particle size from greater than 0 to 0.25 mm.
